(19) United States
(12) Patent Application Publication
(10) Pub. No.: US 2017/0075706 A1
(43) Pub. Date: Mar. 16, 2017

(54) USING EMULATED INPUT/OUTPUT DEVICES IN VIRTUAL MACHINE MIGRATION

(71) Applicant: Red Hat Israel, Ltd., Raanana (IL)

(72) Inventors: Marcel Apfelbaum, Raanana (IL); Gal Hammer, Kfar Saba (IL)

(21) Appl. No.: 14/856,294

(22) Filed: Sep. 16, 2015

(51) Int. Cl. G06F 9/455; G06F 9/48

(52) U.S. Cl. CPC G06F 9/455; G06F 9/4856; G06F 9/45558; G06F 2009/4557

(57) ABSTRACT

Systems and methods for using emulated I/O devices in virtual machine live migration. An example method comprises: creating an emulated input/output (I/O) device corresponding to a virtual function I/O device associated with a virtual machine being migrated from a first host computer system to a second host computer system; intercepting, by a processing device of the first host computer system, virtual machine calls to the virtual function I/O device; processing the intercepted virtual machine calls using the emulated I/O device; and disassociating the virtual function I/O device from the virtual machine.

### TECHNICAL FIELD

The present disclosure is generally related to virtualized computer systems, and is more specifically related to systems and methods for facilitating virtual machine live migration.

### BACKGROUND

Virtualization may be viewed as abstraction of some physical components into logical objects in order to allow running various software modules, for example, multiple operating systems, concurrently and in isolation from other software modules, on one or more interconnected physical computer systems. Virtualization allows, for example, consolidating multiple physical servers into one physical server running multiple virtual machines in order to improve the hardware utilization rate. Virtualization may be achieved by running a software layer, often referred to as “hypervisor,” above the hardware and below the virtual machines. A hypervisor may run directly on the server hardware without an operating system beneath it or as an application running under a traditional operating system. A hypervisor may abstract the physical layer and present this abstraction to virtual machines to use, by providing interfaces between the underlying hardware and virtual devices of virtual machines.

### BRIEF DESCRIPTION OF THE DRAWINGS

The present disclosure is illustrated by way of examples, and not by way of limitation, and may be more fully understood with references to the following detailed description when considered in connection with the figures, in which:

FIG. 1 depicts a high-level component diagram of an example computer system implementing the methods for using emulated input/output (I/O) devices in virtual machine live migration, in accordance with one or more aspects of the present disclosure;

FIG. 2 schematically illustrates the virtual devices being assigned by the hypervisor to a virtual machine, in accordance with one or more aspects of the present disclosure;

FIG. 3 depicts a flow diagram of a method for using emulated I/O devices in virtual machine live migration, in accordance with one or more aspects of the present disclosure; and

FIG. 4 depicts a block diagram of an example computer system operating in accordance with one or more aspects of the present disclosure.

### DETAILED DESCRIPTION

Described herein are methods and systems for using emulated input/output I/O devices in virtual machine live migration.

“Virtual machine live migration” herein refers to the process of moving a running virtual machine from an origin host computer system to a destination host computer system without disrupting the guest operating system and/or the applications executed by the virtual machine. In certain implementations, a migration agent may pre-copy at least a subset of the execution state of the virtual machine being migrated from the origin host to the destination host while the virtual machine is still running at the origin host. Upon completing the state pre-copying operation, the migration agent may optionally switch to a post-copy migration method, by stopping the virtual machine, transferring a subset of the virtual machine execution state (including the virtual processor state and non-pageable memory state) to the destination host, resuming the virtual machine at the destination host, generating a page fault responsive to detecting the virtual machine's attempt to access a memory page which has not yet been transferred, and transferring the page from the origin host to the destination host responsive to the page fault. In certain implementations, the post-copy migration stage may be initiated without pre-copying a subset of the execution state of the virtual machine.

A virtual machine may be associated with various I/O devices, such as disk drive controllers, graphics cards, network interface cards, sound cards, etc. In certain implementations, the hypervisor may support passthrough mode for assigning I/O devices to virtual machines, e.g., in accordance with the single-root I/O virtualization (SR-IOV) specification, which uses physical function (PFs) and virtual functions (VFs). Physical functions are full-featured Peripheral Component Interconnect Express (PCIe) devices that may include all configuration resources and capabilities for the I/O device. Virtual functions are “lightweight” PCIe functions that contain the resources necessary for data movement, but may have a minimized set of configuration resources. An I/O device associated with a virtual machine (e.g., a virtual network interface card) may be provided by a virtual function, thus bypassing the virtual networking on the host in order to reduce the latency between the virtual machine and the underlying physical I/O device.

In certain implementations, migrating a virtual machine having one or more associated virtual function I/O devices (e.g., network interface cards) would involve re-configuring the virtual machine, since a supplemental virtual I/O device would need to be created and connected, via a network bond, to the virtual function I/O device. The virtual machine would need to be re-configured to use the newly created supplemental virtual I/O device. However, introducing the virtual machine re-configuration operation is often undesirable, especially in large cloud environments.

Aspects of the present disclosure address the above noted and other deficiencies by providing methods and systems for using emulated I/O devices in virtual machine live migration. In accordance with one or more aspects of the present disclosure, the hypervisor may expose, to a virtual machine being migrated, an emulated input/output (I/O) device corresponding to a virtual function I/O device. The hypervisor may then disassociate the virtual function I/O device from the virtual machine. The virtual machine may then be stopped at the origin host and re-started at the destination host. Upon re-starting the virtual machine at the destination host, the virtual machine may start using the virtual function I/O device in the pass-through mode.

Various aspects of the above referenced methods and systems are described in details herein below by way of examples, rather than by way of limitation.

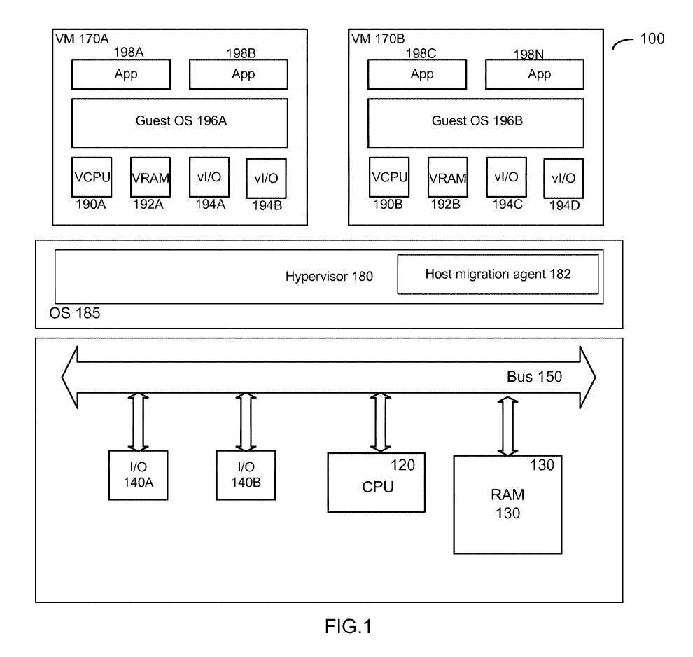

FIG. 1 depicts a high-level component diagram of an illustrative example of a host computer system 100 operating in accordance with one or more aspects of the present disclosure. Host computer system 100 may include one or more processors 120 communicatively coupled to memory devices 130 and input/output (I/O) devices 140 via a system bus 150.

“Processor” herein refers to a device capable of executing instructions encoding arithmetic, logical, or I/O operations. In one illustrative example, a processor may follow Von Neumann architectural model and may include an arithmetic logic unit (ALU), a control unit, and a plurality of registers. In a further aspect, a processor may be a single core processor which is typically capable of executing one instruction at a time (or process a single pipeline of instructions), or a multi-core processor which may simultaneously execute multiple instructions. In another aspect, a processor may be implemented as a single integrated circuit, two or more integrated circuits, or may be a component of a multi-chip module (e.g., in which individual microprocessor dies are included in a single integrated circuit package and hence share a single socket). A processor may also be referred to as a central processing unit (CPU). “Memory device” herein refers to a volatile or non-volatile memory device, such as RAM, ROM, EEPROM, or any other device capable of storing data. “I/O device” herein refers to a device capable of providing an interface between a processor and an external device capable of inputting and/or outputting binary data.

Host computer system 100 may run one or more virtual machines 170A-170B, by executing a software layer 180, often referred to as “hypervisor,” above the hardware and below the virtual machines, as schematically illustrated by FIG. 1. In one illustrative example, hypervisor 180 may be a component of operating system 185 executed by host computer system 100. Alternatively, hypervisor 180 may be provided by an application running under host operating system 185, or may run directly on host computer system 100 without an operating system beneath it. Hypervisor 180 may abstract the physical layer, including processors, memory, and I/O devices, and present this abstraction to virtual machines 170A-170B as virtual devices. A virtual machine 170 may execute a guest operating system 196 which may utilize underlying virtual processors (also referred to as virtual central processing units (vCPUs)) 190, virtual memory 192, and virtual I/O devices 194. One or more applications 198A-198N may be running on a virtual machine 170 under a guest operating system 196.

In various illustrative examples, processor virtualization may be implemented by the hypervisor scheduling time slots on one or more physical processors for a virtual machine, rather than a virtual machine actually having a dedicated physical processor. Memory virtualization may be implementing by a paging mechanism allocating the host RAM to virtual machine memory pages and swapping the memory pages to a backing storage when necessary. Host computer system 100 may support a virtual memory environment in which a virtual machine address space is simulated with a smaller amount of the host random access memory (RAM) and a backing storage (e.g., a file on a disk or a raw storage device), thus allowing the host to over-commit the memory. The virtual machine memory space may be divided into memory pages which may be allocated in the host RAM and swapped to the backing storage when necessary. The guest operating system may maintain a page directory and a set of page tables to keep track of the memory pages. When a virtual machine attempts to access a memory page, it may use the page directory and page tables to translate the virtual address into a physical address. If the page being accessed is not currently in the host RAM, a page-fault exception may be generated, responsive to which the host computer system may read the page from the backing storage and continue executing the virtual machine that caused the exception.

Device virtualization may be implemented by intercepting virtual machine memory read/write and/or input/output (I/O) operations with respect to certain memory and/or I/O port ranges, and by routing hardware interrupts to a virtual machine associated with the corresponding virtual device. In certain implementations, hypervisor 180 may support SR-IOV specification allowing to share a single physical device by two or more virtual machines.

SR-IOV specification enables a single root function (for example, a single Ethernet port) to appear to virtual machines as multiple physical devices. A physical I/O device with SR-IOV capabilities may be configured to appear in the PCI configuration space as multiple functions. SR-IOV specification supports physical functions and virtual functions. Physical functions are full PCIe devices that may be discovered, managed, and configured as normal PCI devices. Physical functions configure and manage the SR-IOV functionality by assigning virtual functions. Virtual functions are simple PCIe functions that only process I/O. Each virtual function is derived from a corresponding physical function. The number of virtual functions that may be supported by a given device may be limited by the device hardware. In an illustrative example, a single Ethernet port may be mapped to multiple virtual functions that can be shared by one or more virtual machines.

Hypervisor 180 may assign one or more virtual functions to a virtual machine, by mapping the configuration space of each virtual function to the guest memory address range associated with the virtual machine. Each virtual function may only be assigned to a single virtual machine, as virtual functions require real hardware resources. A virtual machine may have multiple virtual functions assigned to it. A virtual function appears as a network card in the same way as a normal network card would appear to an operating system.

Virtual functions may exhibit a near-native performance and thus may provide better performance than para-virtualized drivers and emulated access. Virtual functions may further provide data protection between virtual machines on the same physical server as the data is managed and controlled by the hardware.

In various illustrative examples, host computer system 100 depicted in FIG. 1 may act as the origin or as the destination host for migrating virtual machine 170A. Live migration may involve copying the virtual machine execution state from the origin host to the destination host. The virtual machine execution state may comprise the memory state, the virtual processor state, the virtual devices state, and/or the connectivity state.

Hypervisor 180 may include a host migration agent 182 designed to perform at least some of the virtual machine migration management functions in accordance with one or more aspects of the present disclosure. In certain implementations, host migration agent 182 may be implemented as a software component invoked by hypervisor 180. Alternatively, functions of host migration agent 182 may be performed by hypervisor 180.

In an illustrative example, host migration agent 182 may copy, over a network, the execution state of virtual machine 170A, including a plurality of memory pages, from an origin host computer system to a destination host computer system (e.g., host computer system 100 of FIG. 1) without disrupting the guest operating system and/or the applications executed by the virtual machine.

In certain implementations, host migration agent 182 may pre-copy a subset of the execution state of the virtual machine being migrated from the origin host computer system to the destination host computer system while virtual machine 170A is still running at the origin host. Upon completing the state pre-copying operation, host migration agent 182 may switch to a post-copy migration stage. In certain implementations, the post-copy migration stage may be initiated without pre-copying a subset of the execution state of the virtual machine.

During the post-copying migration stage, host migration agent 182 may stop virtual machine 170A, optionally transfer a subset of the virtual machine execution state (including the virtual processor state and non-pageable memory state) to the destination host, and then resume the virtual machine at the destination host.

In the subsequent operation, hypervisor 180 may, responsive to detecting an attempt by virtual machine 170A to access a memory page the contents of which has not yet been transferred from the origin host, generate a page fault. Responsive to the page fault, host migration agent 182 may cause the contents of the memory page to be transmitted by the origin host computer system to the destination host computer system.

As noted herein above, migrating a virtual machine having one or more associated virtual function I/O devices (e.g., network interface cards) may, in certain implementations, involve re-configuring the virtual machine, since a supplemental virtual I/O device would need to be created and connected, via a network bond, to the virtual function I/O device. The virtual machine would need to be re-configured to use the newly created supplemental virtual I/O device. However, introducing the virtual machine re-configuration operation is often undesirable, especially in large cloud environments.

Aspects of the present disclosure provide methods and systems for using emulated I/O devices in virtual machine live migration, thus avoiding the need to re-configure the virtual machine being migrated.

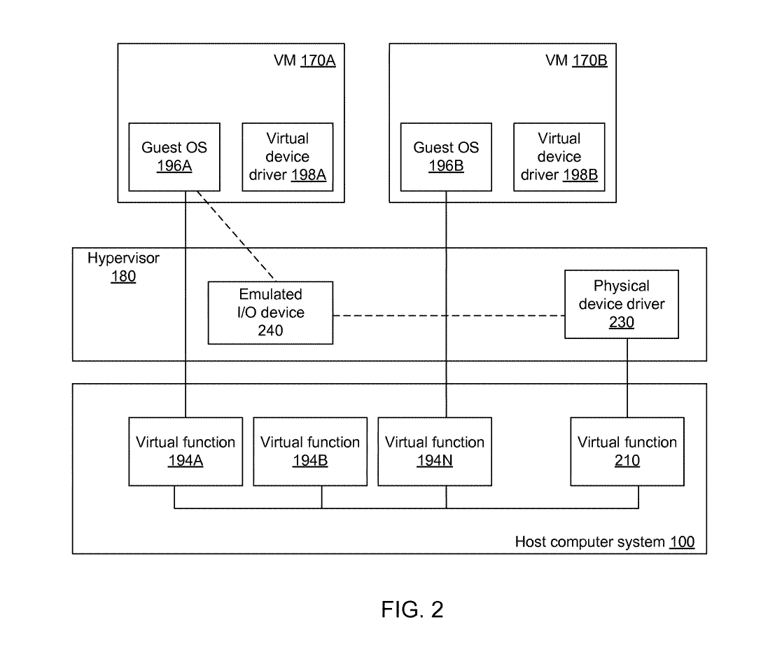

FIG. 2 schematically illustrates the virtual devices being assigned by the hypervisor to a virtual machine, in accordance with one or more aspects of the present disclosure. As shown in FIG. 2, SR-IOV device may have a physical function 210 and multiple virtual functions 220A-220N associated with it. Hypervisor 180 may communicate to physical function 210 via a corresponding physical device driver 230. Virtual functions 194A-194N may be assigned, by hypervisor 180, to one or more virtual machines 170A-170K. Each virtual machine 170A-170K may execute a guest operating system 196A-196K and a virtual device driver 198A-198K facilitating the virtual machine communications with the respective virtual function 194A-194N.

In accordance with one or more aspects of the present disclosure, hypervisor 180 may expose, to virtual machine 170A being migrated from an origin host computer system to a destination host computer system, an emulated I/O device 240 corresponding to virtual function I/O device 194A. In an illustrative example, exposing emulated I/O device 240 to virtual machine 170A may involve intercepting, by hypervisor 180, virtual machine calls to virtual function I/O device 194A (e.g., by re-mapping, to a hypervisor memory buffer, the memory addresses associated with the virtual function I/O device). Having exposed emulated I/O device 240 to virtual machine 170A, hypervisor 180 may start processing, by emulated I/O device 240, the intercepted virtual machine calls to virtual function I/O device 194A. Hypervisor 180 may then disassociate virtual function I/O device 194A from virtual machine 170A.

The host migration agent may then stop virtual machine 170A at the origin host computer system and re-started the virtual machine at the destination host computer system. Upon re-starting virtual machine 170A at the destination host, the virtual machine may start using virtual function I/O device 194A in the pass-through mode.

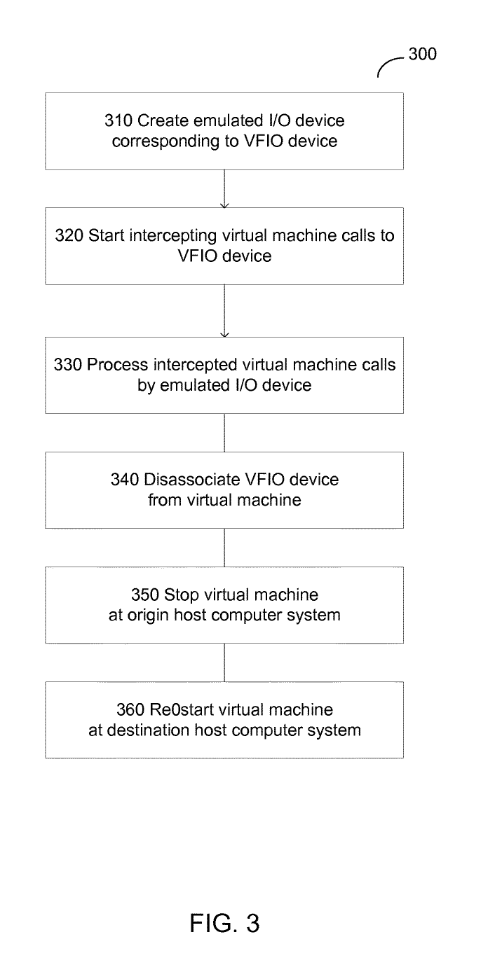

FIG. 3 depicts a flow diagram of one illustrative example of method 300 for using emulated I/O devices in virtual machine live migration, in accordance with one or more aspects of the present disclosure. Method 300 and/or each of its individual functions, routines, subroutines, or operations may be performed by one or more processing devices of the computer system (e.g., host computer system 100 of FIG. 1) implementing the method. In certain implementations, method 300 may be performed by a single processing thread. Alternatively, method 300 may be performed by two or more processing threads, each thread executing one or more individual functions, routines, subroutines, or operations of the method. In an illustrative example, the processing threads implementing method 300 may be synchronized (e.g., using semaphores, critical sections, and/or other thread synchronization mechanisms). Alternatively, the processing threads implementing method 300 may be executed asynchronously with respect to each other.

At block 310, a processing device of a host computer system implementing the method may create an emulated input/output (I/O) device corresponding to a virtual function I/O device associated with a virtual machine being migrated from a first host computer system to a second host computer system, as described in more details herein above.

At block 320, the processing device may start intercepting virtual machine calls to the virtual function I/O device. In an illustrative example, the processing device may re-map, to a hypervisor memory buffer, the memory addresses associated with the virtual function I/O device, as described in more details herein above.

At block 330, the processing device may process, by the emulated I/O device, the intercepted virtual machine calls. Substitution of the virtual function I/O device by the emulated I/O device would be transparent to the virtual machine, and thus would require no virtual machine re-configuration, as described in more details herein above.

At block 340, the processing device may safely disassociate the virtual function I/O device from the virtual machine, as the virtual machine calls directed to the virtual function I/O device would be intercepted and processed by the emulated I/O device, as described in more details herein above.

At block 350, the processing device may stop the virtual machine at the origin host computer system. Responsive to stopping the virtual machine, the processing device may optionally transfer a subset of the virtual machine execution state (including the virtual processor state and non-pageable memory state) to the destination host computer system, as described in more details herein above.

At block 360, the processing device may re-start the virtual machine at the destination host computer system. Upon re-starting the virtual machine at the destination host, the virtual machine may start using the virtual function I/O device in the pass-through mode, as described in more details herein above

Responsive to completing the operations described with reference to block 360, the method may terminate.

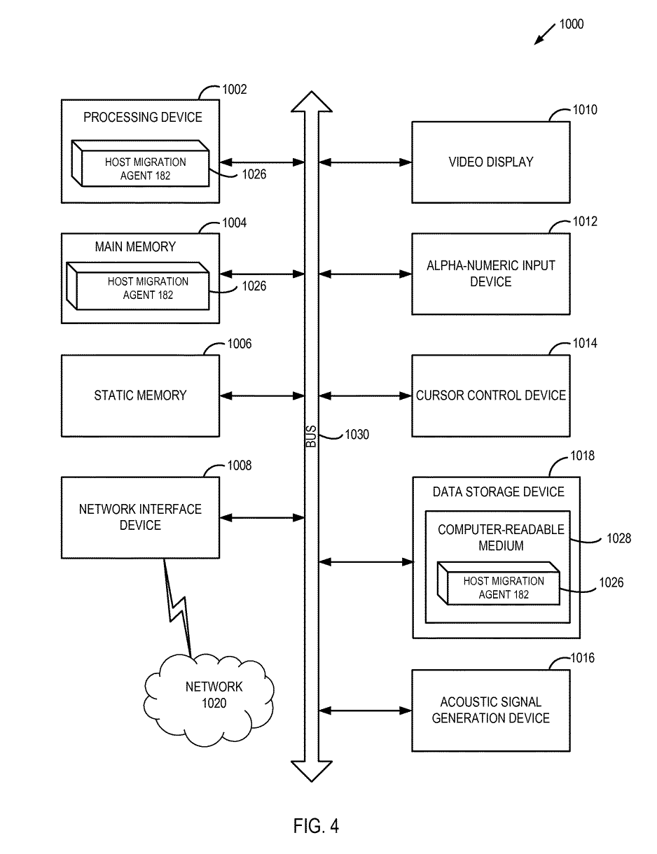

FIG. 4 schematically illustrates a component diagram of an example computer system 1000 which can perform any one or more of the methods described herein. In various illustrative examples, computer system 1000 may represent host computer system 100 of FIG. 1.

Example computer system 1000 may be connected to other computer systems in a LAN, an intranet, an extranet, and/or the Internet. Computer system 1000 may operate in the capacity of a server in a client-server network environment. Computer system 1000 may be a personal computer (PC), a set-top box (STB), a server, a network router, switch or bridge, or any device capable of executing a set of instructions (sequential or otherwise) that specify actions to be taken by that device. Further, while only a single example computer system is illustrated, the term “computer” shall also be taken to include any collection of computers that individually or jointly execute a set (or multiple sets) of instructions to perform any one or more of the methods discussed herein.

Example computer system 1000 may comprise a processing device 1002 (also referred to as a processor or CPU), a main memory 1004 (e.g., read-only memory (ROM), flash memory, dynamic random access memory (DRAM) such as synchronous DRAM (SDRAM), etc.), a static memory 1006 (e.g., flash memory, static random access memory (SRAM), etc.), and a secondary memory (e.g., a data storage device 1018), which may communicate with each other via a bus 1030.

Processing device 1002 represents one or more general-purpose processing devices such as a microprocessor, central processing unit, or the like. More particularly, processing device 1002 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processing device 1002 may also be one or more special-purpose processing devices such as an application specific integrated circuit (ASIC), a field programmable gate array (FPGA), a digital signal processor (DSP), network processor, or the like. In accordance with one or more aspects of the present disclosure, processing device 1002 may be configured to execute host migration agent 182 implementing method 300 for using emulated I/O devices in virtual machine live migration.

Example computer system 1000 may further comprise a network interface device 1008, which may be communicatively coupled to a network 1020. Example computer system 1000 may further comprise a video display 1010 (e.g., a liquid crystal display (LCD), a touch screen, or a cathode ray tube (CRT)), an alphanumeric input device 1012 (e.g., a keyboard), a cursor control device 1014 (e.g., a mouse), and an acoustic signal generation device 1016 (e.g., a speaker).

Data storage device 1018 may include a computer-readable storage medium (or more specifically a non-transitory computer-readable storage medium) 1028 on which is stored one or more sets of executable instructions 1026. In accordance with one or more aspects of the present disclosure, executable instructions 1026 may comprise executable instructions encoding various functions of host migration agent 182 implementing method 300 for using emulated I/O devices in virtual machine live migration.

Executable instructions 1026 may also reside, completely or at least partially, within main memory 1004 and/or within processing device 1002 during execution thereof by example computer system 1000, main memory 1004 and processing device 1002 also constituting computer-readable storage media. Executable instructions 1026 may further be transmitted or received over a network via network interface device 1008.

While computer-readable storage medium 1028 is shown in FIG. 4 as a single medium, the term “computer-readable storage medium” should be taken to include a single medium or multiple media (e.g., a centralized or distributed database, and/or associated caches and servers) that store the one or more sets of VM operating instructions. The term “computer-readable storage medium” shall also be taken to include any medium that is capable of storing or encoding a set of instructions for execution by the machine that cause the machine to perform any one or more of the methods described herein. The term “computer-readable storage medium” shall accordingly be taken to include, but not be limited to, solid-state memories, and optical and magnetic media.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “identifying,” “determining,” “storing,” “adjusting,” “causing,” “returning,” “comparing,” “creating,” “stopping,” “loading,” “copying,” “throwing,” “replacing,” “performing,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Examples of the present disclosure also relate to an apparatus for performing the methods described herein. This apparatus may be specially constructed for the required purposes, or it may be a general purpose computer system selectively programmed by a computer program stored in the computer system. Such a computer program may be stored in a computer readable storage medium, such as, but not limited to, any type of disk including optical disks, CD-ROMs, and magnetic-optical disks, read-only memories (ROMs), random access memories (RAMs), EPROMs, EEPROMs, magnetic disk storage media, optical storage media, flash memory devices, other type of machine-accessible storage media, or any type of media suitable for storing electronic instructions, each coupled to a computer system bus.

The methods and displays presented herein are not inherently related to any particular computer or other apparatus. Various general purpose systems may be used with programs in accordance with the teachings herein, or it may prove convenient to construct a more specialized apparatus to perform the required method steps. The required structure for a variety of these systems will appear as set forth in the description below. In addition, the scope of the present disclosure is not limited to any particular programming language. It will be appreciated that a variety of programming languages may be used to implement the teachings of the present disclosure.

It is to be understood that the above description is intended to be illustrative, and not restrictive. Many other implementation examples will be apparent to those of skill in the art upon reading and understanding the above description. Although the present disclosure describes specific examples, it will be recognized that the systems and methods of the present disclosure are not limited to the examples described herein, but may be practiced with modifications within the scope of the appended claims. Accordingly, the specification and drawings are to be regarded in an illustrative sense rather than a restrictive sense. The scope of the present disclosure should, therefore, be determined with reference to the appended claims, along with the full scope of equivalents to which such claims are entitled.

What is claimed is:

1. A method, comprising:
creating an emulated input/output (I/O) device corresponding to a virtual function I/O device associated with a virtual machine being migrated from a first host computer system to a second host computer system;
intercepting, by a processing device of the first host computer system, a virtual machine call to the virtual function I/O device;
processing the intercepted virtual machine call using the emulated I/O device; and
disassociating the virtual function I/O device from the virtual machine.

2. The method of claim 1, further comprising:
stopping the virtual machine at the first host computer system; and
re-starting the virtual machine at the second host computer system.

3. The method of claim 2, wherein starting the virtual machine at the second host computer system comprises associating the virtual machine with the virtual function I/O device at the second host computer system.

4. The method of claim 1, wherein the virtual function I/O device is provided by a network interface card.

5. The method of claim 1, wherein intercepting the virtual machine calls comprises re-mapping, to a hypervisor memory buffer, a memory address associated with the virtual function I/O device.

6. The method of claim 1, wherein the virtual function I/O device is provided by a single root I/O virtualization (SR-IOV) device.

7. The method of claim 1, further comprising:
copying an execution state of the virtual machine to the second host computer system.

8. A system of a first computer system, comprising:
a memory; and
a processing device, operatively coupled to the memory, to:
create an emulated input/output (I/O) device corresponding to a virtual function I/O device associated with a virtual machine being migrated from the first host computer system to a second host computer system;
re-map, to a hypervisor memory buffer, a memory address associated with the virtual function I/O device;
intercept, by a processing device of the first host computer system, a virtual machine call to the virtual function I/O device;
process the intercepted virtual machine call using the emulated I/O device; and
disassociate the virtual function I/O device from the virtual machine.

9. The system of claim 8, wherein the processing device is further to:
stopping the virtual machine at the first host computer system; and
re-starting the virtual machine at the second host computer system.

10. The system of claim 9, wherein starting the virtual machine at the second host computer system comprises associating the virtual machine with the virtual function I/O device at the second host computer system.

11. The system of claim 8, wherein the virtual function I/O device is provided by a network interface card.

12. The system of claim 8, wherein the virtual function I/O device is provided by a single root I/O virtualization (SR-IOV) device.

13. The system of claim 8, wherein the processing device is further to:
copy an execution state of the virtual machine to the second host computer system.

14. A computer-readable non-transitory storage medium comprising executable instructions to cause a processing device of a first host computer system to:
create an emulated input/output (I/O) device corresponding to a virtual function I/O device associated with a virtual machine being migrated from the first host computer system to a second host computer system;
intercept, by the processing device, a virtual machine call to the virtual function I/O device;
process the intercepted virtual machine call using the emulated I/O device; and
disassociate the virtual function I/O device from the virtual machine.

15. The computer-readable non-transitory storage medium of claim 14, further comprising executable instructions to cause the processing device to:
stop the virtual machine at the first host computer system; and
re-start the virtual machine at the second host computer system.

16. The computer-readable non-transitory storage medium of claim 15, wherein starting the virtual machine at the second host computer system comprises associating the virtual machine with the virtual function I/O device at the second host computer system.

17. The computer-readable non-transitory storage medium of claim 14, wherein the virtual function I/O device is provided by a network interface card.

18. The computer-readable non-transitory storage medium of claim 14, wherein intercepting the virtual machine calls comprises re-mapping, to a hypervisor memory buffer, a memory address associated with the virtual function I/O device.

19. The computer-readable non-transitory storage medium of claim 14, wherein the virtual function I/O device is provided by a single root I/O virtualization (SR-IOV) device.

20. The computer-readable non-transitory storage medium of claim 14, further comprising executable instructions to cause the processing device to:
copy an execution state of the virtual machine to the second host computer system.
